(19) United States
(12) Patent Application Publication
(10) Pub. No.: US 2025/0273419 A1
(43) Pub. Date: Aug. 28, 2025

(54) FUSE UNIT

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Shinichiro YOSHIDA, Osaka (JP); Yuji ONO, Osaka (JP); Osamu NAKAYAMA, Osaka (JP)

(73) Assignees: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(21) Appl. No.: 18/715,943

(22) PCT Filed: Dec. 7, 2022
(86) PCT No.: PCT/JP2022/045154

§ 371 Date: Apr. 21, 2025

(30) Foreign Application Priority Data
Dec. 24, 2021 (JP) 2021-210546

(51) Int. Cl. H01H 85/147; H01H 85/055; H01H 85/175

(52) U.S. Cl. CPC H01H 85/147; H01H 85/055; H01H 85/175

(57) ABSTRACT

A fuse unit 10 includes: a first terminal portion 21 to be connected to a bus bar 70; a second terminal portion 31 to be connected to an electric wire 60; a melting portion 41 that connects the first terminal portion 21 and the second terminal portion 31 to each other and is configured to melt due to overcurrent; and a case 50 covering the melting portion 41. The first terminal portion 21 includes a first connection portion 24 having a contact surface 24A that is to come into contact with the bus bar 70, and a first holding portion 23 that is arranged between the first connection portion 24 and the melting portion 41 and is held by the case 50. The second terminal portion 31 includes a second connection portion 34 to be connected to the electric wire 60, and a second holding portion 33 that is arranged between the second connection portion 34 and the melting portion 41 and is held by the case 50.

### TECHNICAL FIELD

The technique disclosed herein relates to a fuse unit.

### BACKGROUND ART

A battery pack used in an electric vehicle, a hybrid vehicle, or the like includes a plurality of single cells, and a conductor unit (fuse unit) that connects the electrodes of the plurality of single cells and detects the voltage of each single cell. An example of a conductor unit includes a connection conductor connected to an electrode, a relay terminal connected to a terminal end of a voltage detection wire, a fusible body connecting the connection conductor and the relay terminal to each other, and a resin mold member covering the fusible body (see Patent Document 1).

Also, another example of a conductor unit includes a connection terminal that is connected to an electrode and includes a first terminal, a battery-side connector housing inside of which the first terminal is accommodated, a wire-side connector housing that is connected to a terminal end of an electric wire and is fitted into the battery-side connector housing, and a fuse that is accommodated inside the wire-side connector housing and is connected to the first terminal (see Patent Document 2).

### CITATION LIST

### Patent Document

Patent Document 1: JP 2018-097986A.

Patent Document 2: JP 2013-114956A.

### SUMMARY OF INVENTION

### Problem to be Solved by the Invention

In the above-described configuration, since the conductor unit includes a large number of members, there is concern that the configuration will become complicated and the manufacturing cost will increase.

### Solution to the Problem

The fuse unit disclosed herein includes: a first terminal portion to be connected to a partner member; a second terminal portion to be connected to an electric wire; a melting portion that connects the first terminal portion and the second terminal portion to each other and is configured to melt due to overcurrent; and a case covering the melting portion, in which the first terminal portion includes a first connection portion having a contact surface that is to come into contact with the partner member, and a first holding portion that is arranged between the first connection portion and the melting portion and is held by the case, and the second terminal portion includes a second connection portion to be connected to the electric wire, and a second holding portion that is arranged between the second connection portion and the melting portion and is held by the case.

### Advantageous Effects of the Invention

According to the fuse unit disclosed in this specification, the configuration can be simplified and the manufacturing cost can be reduced.

### BRIEF DESCRIPTION OF DRAWINGS

FIG. 1 is a perspective view showing a fuse unit according to an embodiment and a terminal end portion of an electric wire connected to a fuse-equipped unit.

FIG. 2 is a perspective view showing a fuse-equipped terminal of the embodiment and a terminal end portion of an electric wire connected to the fuse-equipped terminal.

FIG. 3 is a front view showing the fuse-equipped terminal of the embodiment and the terminal end portion of the electric wire connected to the fuse-equipped terminal.

FIG. 4 is a perspective view of a case of the embodiment.

FIG. 5 is a side view of the case of the embodiment.

FIG. 6 is a cross-sectional view taken along the line A-A in FIG. 1.

### DESCRIPTION OF EMBODIMENTS

### Overview of Embodiments

(1) The fuse unit disclosed in this specification includes: a first terminal portion to be connected to a partner member; a second terminal portion to be connected to an electric wire; a melting portion that connects the first terminal portion and the second terminal portion to each other and is configured to melt due to overcurrent; and a case covering the melting portion, in which the first terminal portion includes a first connection portion having a contact surface that is to come into contact with the partner member, and a first holding portion that is arranged between the first connection portion and the melting portion and is held by the case, and the second terminal portion includes a second connection portion to be connected to the electric wire, and a second holding portion that is arranged between the second connection portion and the melting portion and is held by the case.

According to the fuse unit having the above-described configuration, the configuration can be simplified and the manufacturing cost can be reduced.

(2) In the fuse unit according to (1) above, the second connection portion may have an electric wire connection region in which the electric wire is connected, and a slit that separates the electric wire connection region and the melting portion from each other.

According to this configuration, it is possible to avoid a case in which heat and vibration generated during the task of connecting the electric wire to the second connection portion are transmitted to the melting portion and adversely affect the melting portion.

(3) The fuse unit according to (1) or (2) may also include an electric wire restraining portion that is connected to the second connection portion and restrains the electric wire.

According to this configuration, it is possible to suppress a case in which the electric wire falls off of the second connection portion.

(4) In the fuse unit according to any one of (1) to (3) above, the case may have an adjacent surface that is adjacent to the contact surface and the adjacent surface is arranged so as to be flush with the contact surface or withdrawn from the contact surface.

According to this configuration, the case does not interfere with the partner member when the first connection portion is connected to the partner member, and the partner member and the fuse unit can be smoothly connected to each other.

(5) In the fuse unit according to any one of (1) to (4) above, the case may have a first insertion portion into which the first holding portion is inserted, and a second insertion portion into which the second holding portion is inserted.

According to this configuration, the first holding portion and the second holding portion can be stably held in the case, and the melting portion arranged between the first holding portion and the second holding portion can be reliably protected.

(6) In the fuse unit according to any one of (1) to (5) above, the first holding portion may have a first engagement hole that engages with the case, and the second holding portion may have a second engagement hole that engages with the case.

According to this configuration, the first holding portion and the second holding portion can be fixed to the case with a simple configuration.

(7) In the fuse unit according to any one of (1) to (6) above, the melting portion is accommodated inside the case in a non-contact state with the case.

According to this configuration, the melting portion can be protected while avoiding a case in which the case comes into contact with the melting portion and damages the melting portion.

### Details of Embodiments

Specific examples of the technique disclosed in this specification will be described below with reference to the drawings. Note that the present invention is not limited to these examples, but is indicated by the scope of the claims, and all changes within the meaning and scope equivalent to the scope of the claims are intended to be encompassed therein.

### Overall Configuration

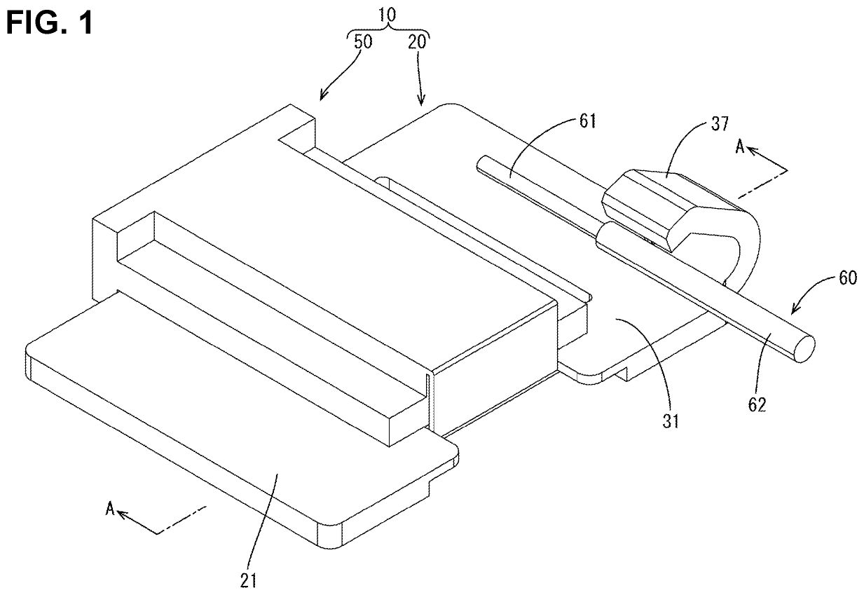

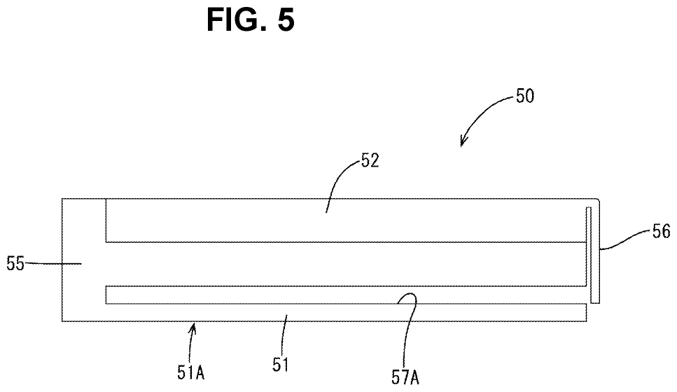

An embodiment will be described with reference to FIGS. 1 to 6. A fuse unit 10 of the present embodiment is connected to a bus bar 70 (an example of a partner member) that connects electrodes of adjacent power storage elements in a power storage module used as a drive source for a vehicle such as an electric vehicle or a hybrid vehicle. The fuse unit 10 includes a fuse-equipped terminal 20 and a case 50, as shown in FIG. 1.

### Fuse-Equipped Terminal 20

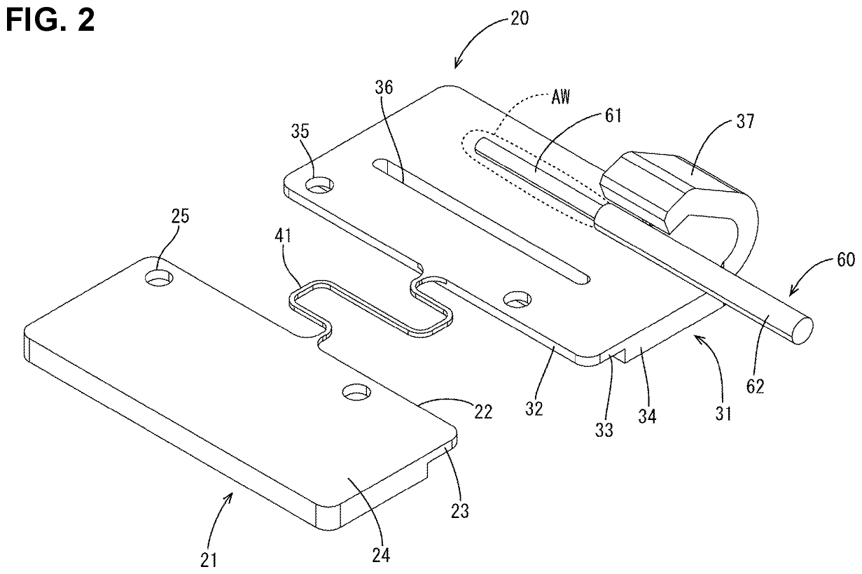

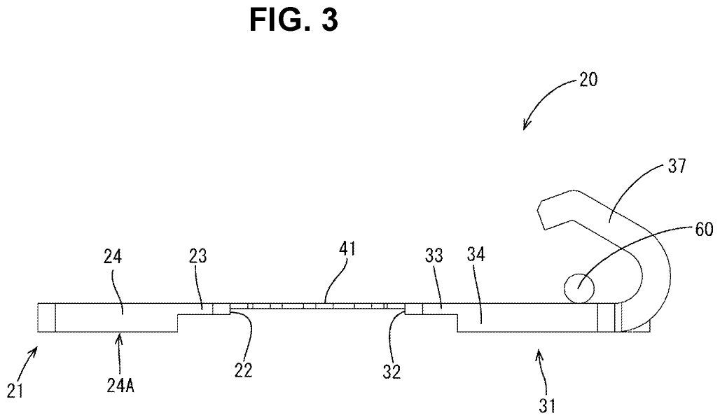

The fuse-equipped terminal 20 is made of metal and is electrically conductive. As shown in FIGS. 2 and 3, the fuse-equipped terminal 20 includes a first terminal portion 21 to be connected to the bus bar 70, a second terminal portion 31 to be connected to the electric wire 60, a melting portion 41 connecting the first terminal portion 21 and the second terminal portion 31, and an electric wire restraining portion 37 that is continuous with the second terminal portion 31.

The first terminal portion 21 and the second terminal portion 31 each have a rectangular plate shape. The first terminal portion 21 and the second terminal portion 31 are arranged in parallel, and the first terminal portion 21 has a first opposing edge 22 opposing the second terminal portion 31, and the second terminal portion 31 has a second opposing edge 32 opposing the first terminal portion 21.

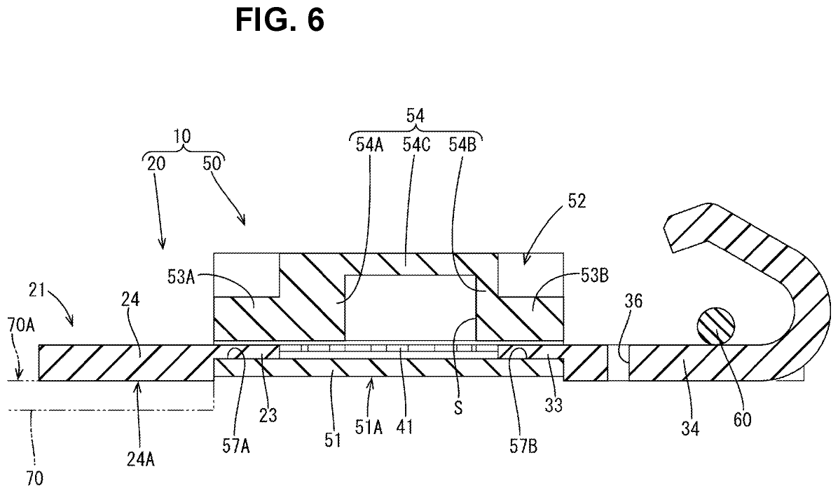

In the first terminal portion 21, the portion adjacent to the first opposing edge 22 is a first holding portion 23, and the remaining portion arranged on the side opposite to the second terminal portion 31 with respect to the first holding portion 23 is a first connection portion 24 that is to be connected to a bus bar 70. The bus bar 70 has a flat surface 70A, and one surface of the first connection portion 24 is a 30 flat contact surface 24A that comes into contact with the flat surface 70A (see FIG. 6). The first connection portion 24 is connected to the bus bar 70 by, for example, laser welding, mechanical clinching, or the like. The first holding portion 23 is thinner than the first connection portion 24. The first holding portion 23 has a plurality of (two in this embodiment) first engagement holes 25.

In the second terminal portion 31, a portion adjacent to the second opposing edge 32 is a second holding portion 33, and the remaining portion located on the side opposite to the first terminal portion 21 with respect to the second holding portion 33 is a second connection portion 34 that is to be connected to an electric wire 60. The second holding portion 33 is thinner than the second connection portion 34. The second holding portion 33 has a plurality of (two in this embodiment) second engagement holes 35.

The electric wire 60 connected to the second connection portion 34 includes a core wire 61 made of a twisted wire obtained by twisting together a plurality of metal strands, and an insulating covering 62 made of a synthetic resin that covers the core wire 61. The core wire 61 has a portion exposed from the insulating covering 62 at the terminal end portion of the electric wire 60. The electric wire 60 is arranged parallel to the second opposing edge 32 on the surface of the second connection portion 34, and is connected by, for example, soldering, ultrasonic welding, or the like.

The melting portion 41 has a thin rod shape and has one end connected to the first opposing edge 22 and another end connected to the second opposing edge 32. The melting portion 41 extends between the first opposing edge 22 and the second opposing edge 32 while meandering in an approximate S shape.

The melting portion 41 is designed to melt when an overcurrent exceeding a predetermined fusing current value flows therein. The material of the melting portion 41 is preferably a metal with a conductivity of 10 to 50% IACS and a low melting point, and zinc alloy, phosphor bronze, aluminum alloy, or the like are preferable. For example, if the material of the fuse-equipped terminal 20 is zinc alloy and the fusing current value is set to 4 amperes, the melting portion 41 preferably has a resistance value of 10 mΩ, a thickness of 0.2 mm, a width of 0.2 mm, and a length of about 10 mm.

The electric wire restraining portion 37 extends from the edge of the second terminal portion 31 opposite to the second opposing edge 32 at an angle with respect to the second connection portion 34, and then is folded back and extends along the second connection portion 34. The electric wire 60 is arranged between the second connection portion 34 and the electric wire restraining portion 37.

In the second connection portion 34, between an electric wire connection region Aw where the electric wire 60 is arranged and the second holding portion 33, a slit 36 is arranged which extends in the direction along the second opposing edge 32 and passes through the second connection portion 34 in the plate thickness direction. This slit 36 separates the electric wire connection region Aw from the melting portion 41. Due to the slit 36 being arranged between the electric wire connection region Aw and the melting portion 41, it is possible to avoid a case in which heat and vibration generated during the task of connecting the electric wire 60 to the second connection portion 34 are transmitted to the melting portion 41 and have an adverse effect on the melting portion 41.

### Case 50

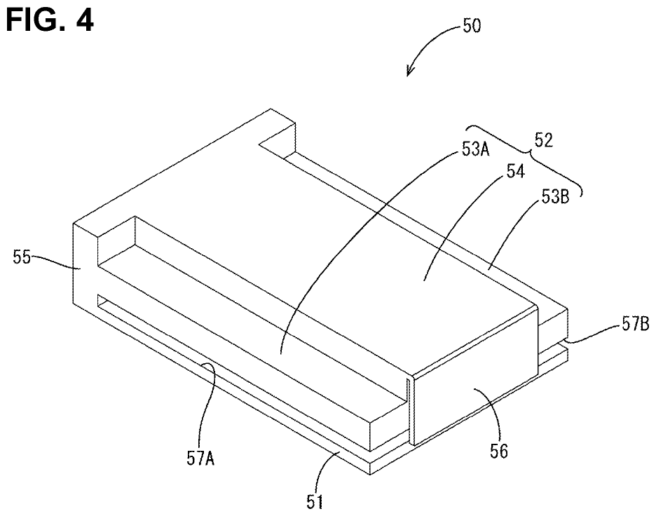

The case 50 is a member that is attached to the fuse-equipped terminal 20 and is for protecting the melting portion 41. The case 50 is made of a synthetic resin, and as shown in FIGS. 4, 5, and 6, the case 50 includes a lower plate portion 51, an upper plate portion 52 arranged opposite to the lower plate portion 51, a joining portion 55 joining the lower plate portion 51 and the upper plate portion 52 to each other, and a stop plate portion 56 extending from the upper plate portion 52.

The lower plate portion 51 has a rectangular flat plate shape. The upper plate portion 52 has a first sandwiching portion 53A and a second sandwiching portion 53B arranged parallel to the lower plate portion 51 with a gap therebetween, and an intermediate portion 54 arranged between the first sandwiching portion 53A and the second sandwiching portion 53B. The first sandwiching portion 53A is arranged along one side edge of the lower plate portion 51, and the second sandwiching portion 53B is arranged along the other side edge of the lower plate portion 51. The intermediate portion 54 includes two side wall portions 54A and 54B that respectively extend from the first sandwiching portion 53A and the second sandwiching portion 53B toward the side opposite to the lower plate portion 51 (the upper side in FIG. 6), and a top wall portion 54C that connects the two side wall portions 54A and 54B.

The gap between the lower plate portion 51 and the first sandwiching portion 53A is equal to or slightly larger than the thickness of the first holding portion 23, and the gap between the lower plate portion 51 and the first sandwiching portion 53A is a first insertion portion 57A that is capable of accommodating the first holding portion 23. Similarly, the gap between the lower plate portion 51 and the second sandwiching portion 53B is equal to or slightly larger than the thickness of the second holding portion 33, and the gap between the lower plate portion 51 and the second sandwiching portion 53B is a second insertion portion 57B that can accommodate the second holding portion 33. A space surrounded by the intermediate portion 54 and the lower plate portion 51 is a fuse accommodating space S that is in communication with the first insertion portion 57A and the second insertion portion 57B.

The joining portion 55 is a wall that connects one end of the upper plate portion 52 and one end of the lower plate portion 51. The stop plate portion 56 extends from the other end of the top wall portion 54C on the side opposite to the joining portion 55. The stop plate portion 56 can be displaced between a closed position in which the stop plate portion 56 extends toward the lower plate portion 51 and the opening on the side opposite to the joining portion 55 in the fuse accommodating space S is closed, and an open position in which the stop plate portion 56 extends in a direction parallel to the lower plate portion 51 and the opening on the side opposite to the joining portion 55 in the fuse accommodating space S is open.

### Attaching Fuse Terminal 20 and Case 50

When attaching the fuse-equipped terminal 20 to the case 50, the first holding portion 23 is inserted into the first insertion portion 57A and the second holding portion 33 is inserted into the second insertion portion 57B while the stop plate portion 56 is in the open position. When the insertion is complete, the stop plate portion 56 is moved to the closed position.

When the case 50 is attached to the fuse-equipped terminal 20, as shown in FIG. 6, the first holding portion 23, the second holding portion 33, and the melting portion 41 are arranged between the lower plate portion 51 and the upper plate portion 52. The first holding portion 23 is accommodated in the first insertion portion 57A, and the second holding portion 33 is accommodated in the second insertion portion 57B. The first connection portion 24 and the second connection portion 34 are exposed to the outside from the case 50. The first connection portion 24 and the second connection portion 34 protrude toward mutually opposite sides relative to the case 50. There are gaps between the lower plate portion 51 and upper plate portion 52 and the melting portion 41, and the case 50 is attached to the fuse-equipped terminal 20 while the melting portion 41 is not in contact with the case 50. In particular, inside the case 50, there is a relatively large fuse accommodating space S surrounded by the intermediate portion 54 and the lower plate portion 51, and most of the melting portion 41 is arranged inside this fuse accommodating space S. As a result, contact between the melting portion 41 and the case 50 can be avoided as much as possible.

After the case 50 is attached to the fuse-equipped terminal 20, for example, due to the surface of the first sandwiching portion 53A being pressed with a pin, a portion of the first sandwiching portion 53A undergoes plastic deformation and protrusions that respectively enter the two first engagement holes 25 of the first holding portion 23 are formed. As a result, the first holding portion 23 is fixed to the case 50. Similarly, due to the surface of the second sandwiching portion 53B being pressed with a pin, protrusions that respectively enter the two second engagement holes 35 of the second holding portion 33 are formed, and the second holding portion 33 is fixed to the case 50.

The thickness of the first connection portion 24 is greater than the sum of the thickness of the first holding portion 23 and the thickness of the lower plate portion 51. As a result, in the lower plate portion 51, the outer surface (adjacent surface 51A) adjacent to the contact surface 24A is arranged so as to be withdrawn toward the upper plate portion 52 (upward in FIG. 6) relative to the contact surface 24A. This prevents the case 50 from interfering with the bus bar 70 when the first connection portion 24 is connected to the bus bar 70.

### Operations and Effects

As described above, according to the present embodiment, the fuse unit 10 includes the first terminal portion 21 that is to be connected to the bus bar 70, the second terminal portion 31 that is to be connected to the electric wire 60, the melting portion 41 that connects the first terminal portion 21 and the second terminal portion 31 and is configured to melt due to overcurrent, and a case 50 that covers the melting portion 41. The first terminal portion 21 includes the first connection portion 24 that has the contact surface 24A that is to come into contact with the bus bar 70, and the first holding portion 23 that is arranged between the first connection portion 24 and the melting portion 41 and is held in the case 50. The second terminal portion 31 includes the second connection portion 34 that is to be connected to the electric wire 60, and the second holding portion 33 that is arranged between the second connection portion 34 and the melting portion 41 and is held by the case 50.

According to the fuse unit 10 having the above-described configuration, the configuration can be simplified and manufacturing cost can be reduced.

Also, the second connection portion 34 has the electric wire connection region Aw to which the electric wire 60 is connected, and the slit 36 that separates the electric wire connection region Aw and the melting portion 41 from each other. According to this configuration, it is possible to avoid a case in which heat and vibration generated during the task of connecting the electric wire 60 to the second connection portion 34 are transmitted to the melting portion 41 and have an adverse effect on the melting portion 41.

Also, the fuse unit 10 includes the electric wire restraining portion 37 that is connected to the second connection portion 34 and restrains the electric wire 60. According to this configuration, it is possible to suppress the electric wire 60 from falling off of the second connection portion 34.

Also, the case 50 has the adjacent surface 51A adjacent to the contact surface 24A, and the adjacent surface 51A is arranged so as to be flush the contact surface 24A or withdrawn from the contact surface 24A.

According to this configuration, the case 50 does not interfere with the bus bar 70 when the first connection portion 24 is connected to the bus bar 70, and the bus bar 70 and the fuse unit 10 can be smoothly connected to each other.

Also, the case 50 has the first insertion portion 57A into which the first holding portion 23 is inserted, and the second insertion portion 57B into which the second holding portion 33 is inserted.

According to this configuration, the first holding portion 23 and the second holding portion 33 can be stably held in the case 50, and the melting portion 41 arranged between the first holding portion 23 and the second holding portion 33 can be reliably protected.

Also, the first holding portion 23 has the first engagement holes 25 that engage with the case 50, and the second holding portion 33 has the second engagement holes 35 that engage with the case 50. According to this configuration, the first holding portion 23 and the second holding portion 33 can be fixed to the case 50 with a simple structure.

Also, the melting portion 41 is accommodated inside the case 50 in a non-contact state with respect to the case 50. According to this configuration, the melting portion 41 can be protected while preventing the case 50 from coming into contact with the melting portion 41 and damaging the melting portion 41.

### Other Embodiments

(1) In the above-described embodiment, the shapes of the first terminal portion 21 and the second terminal portion 31 are rectangular plate shapes, but the shapes of the first terminal portion and the second terminal portion are not limited to the above-described embodiment. For example, the second terminal portion may also include a caulking portion for caulking the core wire.

(2) In the above-described embodiment, the melting portion 41 meandered in an S shape, but for example, the melting portion may also be V-shaped, U-shaped, crank-shaped, or linear.

(3) The mode of fixing the case 50, the first holding portion 23, and the second holding portion 33 is not limited to the above-described embodiment, and for example, the case, the first holding portion, and the second holding portion may also be fixed through heat caulking to form protrusions that enter the engagement holes of the first holding portion and the second holding portion.

(4) The partner member does not need to be a bus bar, and may also be, for example, an electrode terminal.

(5) In the above-described embodiment, the adjacent surface 51A of the case 50 was arranged so as to be withdrawn from the contact surface 24A, but the adjacent surface and the contact surface may also be flush with each other.

### List of Reference Numerals

10 Fuse unit
20 Fuse-equipped terminal
21 First terminal portion
22 First opposing edge
23 First holding portion
24 First connection portion
24A Contact surface
25 First engagement hole
31 Second terminal portion
32 Second opposing edge
33 Second holding portion
34 Second connection portion
35 Second engagement hole
36 Slit
37 Electric wire restraining portion
41 Melting portion
50 Case
51 Lower plate portion
51A Adjacent surface
52 Upper plate portion
53A First sandwiching portion
53B Second sandwiching portion
54 Intermediate portion
54A, 54B Side wall portion
54C Top wall portion
55 Joining portion
56 Stop plate portion
57A First insertion portion
57B Second insertion portion
60 Electric wire
61 Core wire
62 Insulating covering
70 Bus bar (partner member)
70A Flat surface
Aw Electric wire connection region
S Fuse accommodating space

1. A fuse unit, comprising:
a first terminal portion to be connected to a partner member;
a second terminal portion to be connected to an electric wire;
a melting portion that connects the first terminal portion and the second terminal portion to each other and is configured to melt due to overcurrent; and
a case covering the melting portion,
wherein the first terminal portion includes a first connection portion having a contact surface that is to come into contact with the partner member, and a first holding portion that is arranged between the first connection portion and the melting portion and is held by the case, and
the second terminal portion includes a second connection portion to be connected to the electric wire, and a second holding portion that is arranged between the second connection portion and the melting portion and is held by the case.

2. The fuse unit according to claim 1,
wherein the second connection portion has an electric wire connection region in which the electric wire is connected, and a slit that separates the electric wire connection region and the melting portion from each other.

3. The fuse unit according to claim 1 or 2, further comprising
an electric wire restraining portion that is connected to the second connection portion and restrains the electric wire.

4. The fuse unit according to any one of claims 1 to 3,
wherein the case has an adjacent surface that is adjacent to the contact surface and the adjacent surface is arranged so as to be flush with the contact surface or withdrawn from the contact surface.

5. The fuse unit according to any one of claims 1 to 4,
wherein the case has a first insertion portion into which the first holding portion is inserted, and a second insertion portion into which the second holding portion is inserted.

6. The fuse unit according to any one of claims 1 to 5,
wherein the first holding portion has a first engagement hole that engages with the case, and the second holding portion has a second engagement hole that engages with the case.

7. The fuse unit according to any one of claims 1 to 6,
wherein the melting portion is accommodated inside the case in a non-contact state with the case.
